(19) United States
(12) Patent Application Publication
(10) Pub. No.: US 2025/0360932 A1
(43) Pub. Date: Nov. 27, 2025

(54) ENERGY OPTIMIZATION FOR A VEHICLE BASED ON PASSENGER OBSERVATION

(71) Applicant: Intel Corporation, Santa Clara, CA (US)

(72) Inventors: Fabian OBORIL, Karlsruhe (DE); Cornelius BUERKLE, Karlsruhe (DE)

(21) Appl. No.: 19/186,650

(22) Filed: Apr. 23, 2025

(30) Foreign Application Priority Data
May 27, 2024 (DE) 10 2024 114 803.9

(51) Int. Cl. B60W 50/00; B60W 40/08

(52) U.S. Cl. CPC B60W 50/0098; B60W 40/08; B60W 2050/0083; B60W 2420/403; B60W 2420/408; B60W 2540/229

(57) ABSTRACT

Disclosed herein are devices, methods, and systems for energy optimization of vehicles based on observing passengers and the interior of the vehicle. A processor is configured to determine an energy reduction scheme for a subsystem of the vehicle. The energy reduction scheme is based on a passenger status of a passenger who is within a passenger environment of the vehicle. The energy reduction scheme is configured to reduce the power consumption of the subsystem with respect to the vehicle. The processor is also configured to control a configuration setting of the subsystem of the vehicle based on the energy reduction scheme.

### CROSS-REFERENCE TO RELATED APPLICATION(S)

This application claims priority to German Application No. 10 2024 114 803.9 filed on May 27, 2024, the contents of which is fully incorporated herein by reference.

### TECHNICAL FIELD

The disclosure relates generally to energy optimization for vehicles, and in particular to energy optimization based on observing passengers and on other observations in the interior of the vehicle, in order to define configuration settings that have an effect on the power consumption of the vehicle with respect to the interior functions.

### BACKGROUND

The power consumption of vehicles has become more important with the rise in energy prices and the transition from gasoline to battery, solar and other alternative fuel sources. At the same time, vehicles contain ever more electronic devices and electronic functions, which consume a large amount of power, ranging from infotainment and display screens to heating and cooling systems. Currently, the opportunities for saving energy in vehicles are very limited and are normally focused on movement aspects of the vehicle, for instance an energy-efficient driving mode which limits the acceleration, recovers energy during braking, and increases the vehicle autonomy so that optimum situational driving strategies can be employed to define energy-efficient movements when making movement decisions. The focus of these energy-saving methods is on reducing the power consumption for the propulsion and the movement-related actions of the vehicle. Despite these energy-saving methods, there are still many other functions of the vehicle that consume a large amount of power and are possibly not efficient enough.

### BRIEF DESCRIPTION OF THE DRAWINGS

In the drawings, the same reference signs denote in general the same parts in the different views. The drawings are not necessarily to scale, with the focus being generally on illustrating the exemplary principles of the disclosure. In the following description, various exemplary aspects of the disclosure are described with reference to the following drawings, in which:

FIG. 1 shows an example of a vehicle, which is equipped with monitoring systems for passengers and in the cabin that can be used to make decisions about the energy management of the systems in the cabin;

FIG. 2 shows an example of an energy management system, which can use observations of the passengers and the state of the vehicle and/or navigation information to make decisions about the energy configuration of the systems in the cabin;

FIG. 3 shows an example of three different levels of the energy settings for a video system in the cabin and transitions between the levels, which can be linked to an observed state of a passenger with respect to the video system;

FIG. 4 shows an example of different energy settings for a video system, which can be used on the basis of observations of the passengers;

FIG. 5 shows an exemplary information flow in an energy management system with reference to an example of using observations of the passengers, navigation information and vehicle information to define the configuration settings for the heating/cooling systems in the cabin;

FIG. 6 shows an exemplary apparatus, which can be used to make decisions about the energy management for systems in the cabin; and

FIG. 7 shows an exemplary flow diagram of a method of an energy management system, which can be used to make decisions about the energy management for systems in the cabin.

### DESCRIPTION

The following detailed description relates to the accompanying drawings, which show exemplary details and features for illustrative purposes.

The word “exemplary” is used herein in the sense of “serving as an example, instance or illustration”. Each aspect or each design described here as “exemplary” shall not be interpreted as necessarily preferred or advantageous over other aspects or designs.

In the drawings, unless stated otherwise, the same reference numbers are used to denote identical or similar elements, features and structures.

The expressions “at least one” and “one or more” can be understood to mean that they include a numeric amount greater than or equal to one (e.g., one, two, three, four, [ . . . ] etc.). The wording “at least one of” with reference to a group of elements can be used herein to mean at least one element from the group comprising the elements. For example, the wording “at least one of” with reference to a group of elements can be used herein to mean a selection of: one of the listed elements, a plurality of one of the listed elements, a plurality of individual listed elements, or a plurality of a multiple of individual listed elements.

The words “plural” and “multiple” in the description and in the claims refer expressly to an amount greater than one. Accordingly, all expressions which expressly refer to the above-mentioned words (for example, a plurality of [elements], multiple [elements]) refer to a set of elements, specifically to more than one of the stated elements. For instance, the wording “a plurality of” can be understood to mean that it includes a numeric amount greater than or equal to two (e.g., two, three, four, five, [ . . . ] etc.).

The expressions “group (of)”, “set (of)”, “collection (of)”, “series (of)”, “sequence (of)”, “grouping (of)” etc. in the description and in the claims, if present, refer to an amount which is greater than or equal to one, i.e. one or more. The terms “proper subset”, “reduced subset” and “smaller subset” refer to a subset of a set that is not equal to the set, for example a subset of a set that contains fewer elements than the set.

The term “data” used herein can be understood to mean that it includes information in any suitable analog or digital form, for instance in the form of a file, part of a file, a set of files, a signal or stream, part of a signal or stream, a set of signals or streams, and the like. In addition, the term “data” can also be used as a reference to information, for example in the form of a pointer. The term “data” is not restricted to the above-mentioned examples, however, but can assume various forms and represent any type of information as understood in the technical world.

The terms “processor” or “controller” used herein can be understood to be any type of technological unit (for example, hardware, software and/or a combination of both) that facilitates the processing of data. The data can be processed in accordance with one or more specific functions that can be executed by the processor or the control unit. In addition, a processor or a controller, as used herein, can be understood to be any type of circuit, for example any type of analog or digital circuit. A processor or a control unit can therefore be or include an analog circuit, a digital circuit, a mixed-signal circuit, software, firmware, hardware, a logic circuit, a processor, a microprocessor, a central processing unit (CPU), a graphics processing unit (GPU), a digital signal processor (DSP), a field-programmable gate arrangement (FPGA), an integrated circuit, an application-specific integrated circuit (ASIC), etc., or any combination thereof. Any other form of implementation of the respective functions that is described in more detail below can likewise be understood to be a processor, controller, or logic circuit. It is evident that two (or more) of the processors, controllers or logic circuits described herein can be realized as a single unit of equivalent functionality or the like, and conversely that a single processor described herein, a single controller or logic circuit can be realized as two (or more) separate units of equivalent functionality or the like.

The term “memory” here denotes a computer-readable medium (e.g. a non-transitory computer-readable medium) in which data or information can be stored for retrieval. If reference is made herein to a “memory”, this can mean a volatile or non-volatile memory, including a random access memory (RAM), a read-only memory (ROM), a flash memory, a solid-state memory, a magnetic tape, a hard drive, an optical drive, a 3D X Point™, or any combination thereof. The term “memory” also includes registers, shift registers, processor registers, data buffers, and others. The term “software” refers to all types of executable commands, including firmware.

If not expressly indicated, the term “transmission” includes both direct (point-to-point) and indirect transmission (via one or more intermediate points). Similarly, the term “receive” includes both direct and indirect reception. In addition, the terms “send”, “receive”, “communicate”, and similar terms include both physical transmission (for example, the transmission of radio signals) and logical transmission (for example, the transmission of digital data via a logic connection at the software level). For example, a processor or a control unit can transmit or receive data in the form of radio signals via a connection at the software level with another processor or another control unit, wherein the physical transmission and the reception are handled by components of the radio layer such as RF transceivers and antennas, and the logical transmission and the reception are carried out by the processors or control units via the connection at the software level. The term “communicate” includes both sending and receiving, i.e. unidirectional or bidirectional communication in one or both directions, i.e. incoming and outgoing. The term “calculate” includes both “direct” calculations by means of a mathematical expression/a formula/a relationship and “indirect” calculations by means of lookup tables or hash tables and other array indexing or search operations.

A “vehicle” can be understood to be any type of propelled object. A vehicle can be, for example, a propelled object having an internal combustion engine, a reaction motor, an electrically powered object, a hybrid-powered object, or a combination thereof. A vehicle can be or include, inter alia, an automobile, a bus, a minibus, a delivery vehicle, a truck, a caravan, a vehicle trailer, a motorcycle, a bicycle, a three-wheeled vehicle, a train locomotive, a train car, a driving robot, a personnel transporter, a boat, a ship, a submersible, a submarine, a drone, an aircraft, or a rocket.

The term “autonomous vehicle” can specify a vehicle capable of performing at least one vehicle maneuver without intervention by the driver. A vehicle maneuver can specify or include a change to the steering, to the braking, to the acceleration/deceleration, etc. of the vehicle. A vehicle can be referred to as autonomous even when it is not fully automatic (for example, fully functional with driver input or without driver input). Autonomous vehicles can include vehicles which can be operated during certain periods of time under the supervision of the driver and during other periods of time without supervision of the driver. Autonomous vehicles can also include vehicles which only control some aspects of the vehicle navigation, for instance the steering (for example, to maintain a vehicle course between the lane boundaries) or some steering operations under certain circumstances, but under other circumstances can leave other aspects of the vehicle navigation to the driver (for example, braking under certain circumstances). Autonomous vehicles can also include vehicles which share the supervision over one or more aspects of the implementation/planning of vehicle maneuvers under certain circumstances (for example, “hands-on”, i.e. in response to a driver input), and vehicles that supervise one or more aspects of the vehicle maneuver under certain circumstances (for example, “hands off”, i.e. independently of the driver input). Autonomous vehicles can also include vehicles that control one or more aspects of the vehicle navigation under certain circumstances, for example under certain environmental conditions (for example, spatial areas, roadway conditions). In some cases, autonomous vehicles can take over some or all aspects of the braking, the speed control, the speed regulation and/or the steering of the vehicle.

Autonomous vehicles also include vehicles which can drive without a driver. The degree of autonomy of a vehicle can be defined by the SA E level of the vehicle (for example, according to the definition by the SAE, e.g. in SAE J 3016 2018: Taxonomy And Definitions For Terms Related To Driving Automation Systems For On Road Motor Vehicles) or by other relevant professional organizations. The SAE level can have a value ranging from a minimum level, for instance level 0 (for illustration: essentially no driving automation) to a highest level, for instance level 5 (for illustration: complete driving automation).

As already mentioned, the focus of present energy-saving methods for vehicles is on reducing the power consumption for the propulsion and the movement-related actions of the vehicle. Despite these existing energy-saving methods, there are many other aspects of the vehicle that consume large amounts of power. In order to provide comfort for the passengers inside the vehicle, for example, modern vehicles often have functions that consume a large amount of power: powerful heaters, heated seats, cooled seats, powerful air-conditioning systems, high-resolution displays, etc. If such systems are offered in an electric vehicle, for example, then if used by the passengers they can reduce the available range of the electric vehicle by 10-40%. This can be the case, for example, on hot summer days when a powerful air-conditioning facility is wanted, or on cold winter days when heating is wanted.

As explained later in more detail, the disclosed energy management system can use information about the passenger of the vehicle in order to configure the systems in the cabin in an energy-efficient manner. For example, modern vehicles can be equipped with monitoring systems such as red-green-blue (RGB) cameras or other types of sensor in order to monitor the passengers, their behavior in the vehicle and other aspects of the vehicle that have an effect on the environment in the interior. On the basis of this data and also the navigation data and other vehicle-related data, the energy management system can set suitable energy configurations for systems in the vehicle interior such as heating, cooling, heated/cooled seats, ventilation systems, visual display systems, infotainment systems, radios, etc. If the passenger does not need, is not fully using, or cannot fully use a particular system in the cabin, then it can be configured such that it operates in a reduced-energy mode or is simply switched off until the passenger needs it again.

Controlling the systems in the vehicle cabin in this way can achieve substantial energy savings. For example, systems in the cabin that are focused on the comfort of the passengers can require, as a rough estimate, 1 kWh to 5 kWh, which constitutes between 5 and 30% of the total energy requirement of an electric vehicle (which typically equals in total 12 to 18 kWh). The table below lists typical components and their typical power consumption:

| Component | Power consumption | |
|---|---|---|
| OLED displays | 100-200 | Watts |
| Ventilation set to “moderate” | 170 | Watts |
| Air-conditioning | 500 | Watts |
| In-seat heating | 100-200 | Watts |
| Heating facility | 1000-5000 | Watts |

Based on the rough estimates above, on a hot summer's day, the power required to operate the displays and the air-conditioning facility (including the fans) equals about 800-900 Watts, while on a cold winter's day, on which heating is additionally activated, the power consumption can rise to 5 kW. This is a large portion of the power consumption that can be used by the energy management system for energy savings by configuring these systems in the cabin intelligently in order to reduce the power consumed by these components in the cabin while maintaining the comfort of the passengers. The disclosed energy management system can recognize the presence, the state, the behavior, etc. of the various passengers in the vehicle and, on the basis of these observations of the passengers, can perform an automatic and fine-grained adjustment to the different systems in the cabin. As a result, for example, the energy needed by the systems in the cabin can be reduced substantially, thereby improving the overall power consumption of the vehicle (and in an electric vehicle (EV), this can be reflected, for instance, in a greater range that the vehicle can cover with a certain state of battery charge).

If, for example, it is known (for instance by a navigation system) that the vehicle must travel for only five minutes to reach its destination, that it is a cold winter's day and all the passengers are wearing thick warm clothing, there may not be a need to operate the heating up to the upper power limit because the vehicle will not get warm anyway by the time it reaches the destination. Thus the heating system can be configured to work in a lower-energy mode, which is based on the warm clothing of the passengers and the short planned journey time to the destination. Similarly, a display in the cabin can be dimmed, be configured to have a lower video refresh rate or a lower resolution if no passenger is paying attention to it, allowing a reduction in the power consumption of the display in the cabin. The disclosed energy management system can thereby reduce the power consumption of devices in the cabin on the basis of the observation of the passengers. The energy management system can be optimized such that the power consumption of the devices in the cabin is minimized while a high degree of comfort is maintained for the passengers.

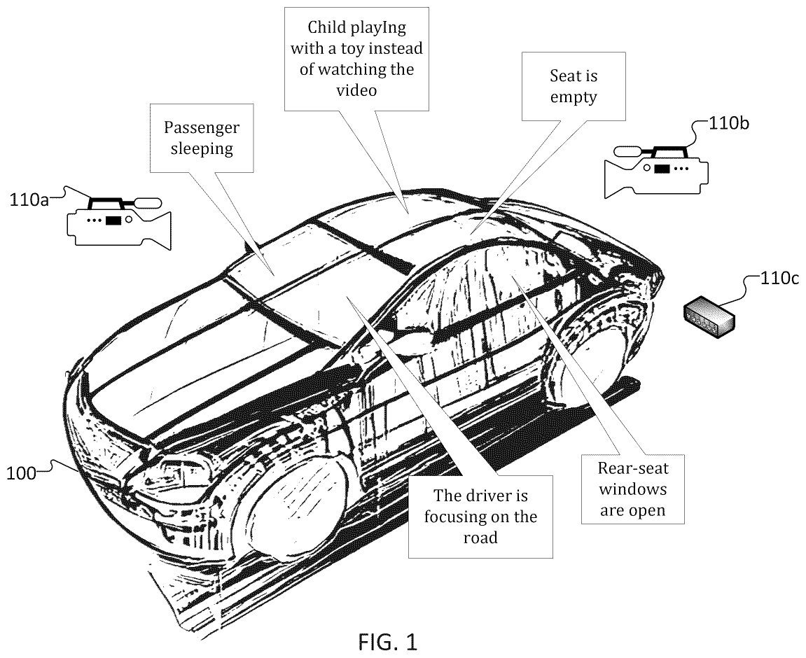

FIG. 1 shows an example of a vehicle 100, which is equipped with monitoring systems for passengers and cabin that can be used by an energy management system to make decisions about the energy management for the systems in the cabin. For example, the vehicle 100 can use a rear-facing interior camera 110a, a front-facing interior camera 110b, an interior temperature sensor 110c, and any other type of sensor or sensor data about the interior state of the vehicle, the state/behavior of the passengers, the navigation information about the vehicle, and/or the operating state of the vehicle in order to make decisions about the energy configuration for the interior systems such as heating, cooling, ventilation, display screens, etc.

For example, the camera data from the rear-facing camera 110a and/or from the front-facing camera 110b can be used to ascertain that a passenger is sleeping and the driver is concentrating on the road. On the basis of this information, the energy management system can darken the front console and/or operate the display of the infotainment system in a lower-energy mode (for example lower brightness, lower frame rate, lower resolution, switched off, etc.) while the passenger is sleeping and the eyes of the driver remain focused on the road. Similarly, the energy management system can use the rear-facing camera 110a and/or the front-facing camera 110b to ascertain that the child in the rear seat is not looking at the screen but instead is playing with a toy. As a result, the energy management system can pause the video until the child's attention returns to the video system. A further example: the energy management system can ascertain that the rear window is open and the temperature is indicating a suitable air temperature for the child. In this case, the energy management system can reduce the speed of the fans to the rear air vents because there is a sufficient flow of air and the air temperature is close to the desired temperature setting. These are obviously only some examples of the types of energy configurations that the energy management system can set on the basis of information about the passengers.

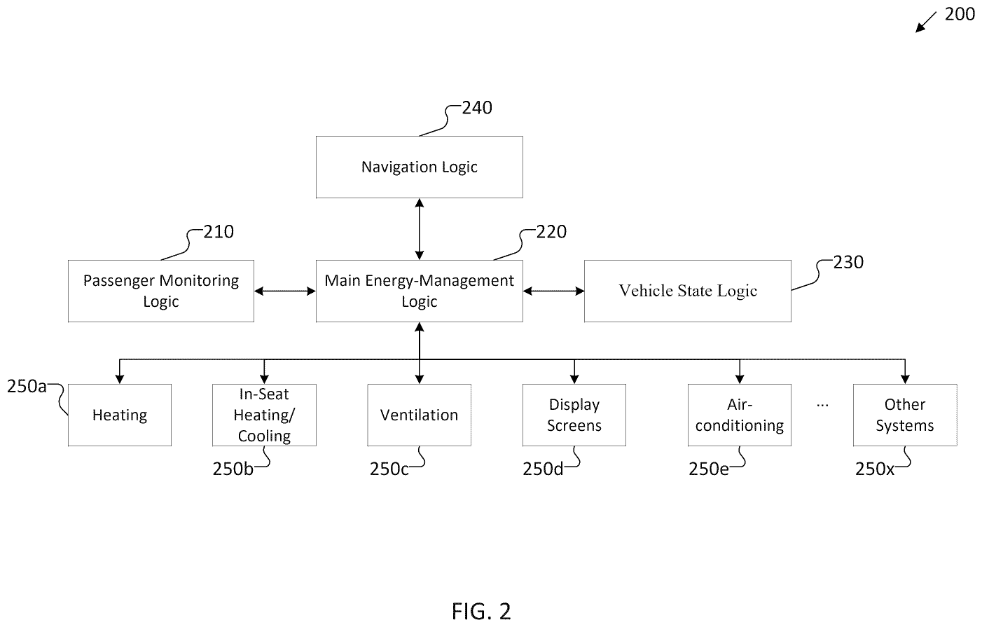

FIG. 2 shows an example of an energy management system 200, which can use observations of passengers and the state of the vehicle and/or navigation information to make decisions about the energy configuration for systems in the cabin. The energy management system 200 can contain main energy-management logic 220, which defines the energy configuration settings for systems in the cabin on the basis of information about the passengers, navigation information, and/or other vehicle information. For example, passenger monitoring logic 210 can use sensor data about the interior of a vehicle, and in particular about the passengers inside the vehicle, to supply the main energy-management logic 220 with information about the passengers.

The passenger monitoring logic 210 can contain any type of sensor, for instance camera-based sensors, environment sensors, occupancy sensors, etc., in order to monitor the interior of the vehicle. The passenger monitoring logic 210 can provide information such as the following, which can be determined by sensor-based (for example camera-based, sensor fusion, etc.) face/gesture recognition, which can use artificial intelligence models to establish the behavior of the passengers from sensor data:

$$for each passenger {p}_{i} ∈ P = \{ list of passengers \} : \\ location {l}_{i} ∈ S = \{ list of seats \} \\ pose {ρ}_{i} \\ gaze {g}_{i} \\ activity {a}_{i} ∈ A = \{ active driving , sleeping , playing , reading , etc . \} \\ clothing {c}_{i} ∈ C = \{ e . g . thick winter clothing , summer clothes , etc . \}$$

The navigation logic 240 can supply the main energy-management logic 220 with information about the expected time of arrival at the destination, the time until the next navigation command or any other type of navigation information that can be available in typical navigation and geolocation logic.

The vehicle state logic 230 can provide the main energy-management logic 220 with information about the state of the vehicle, for example the external temperature of the surroundings of the vehicle, the temperature in the interior, whether and to what extent the windows can be opened or closed, the speed, the acceleration, the angular velocity of the vehicle, etc.

It should be clear that the above list of passenger-related information, navigation information and vehicle information is merely by way of example and that any type of information that may be useful to the main energy-management logic 220 for defining the energy configurations for the devices in the cabin can be captured, analyzed and provided to the main energy-management logic 220 by the passenger monitoring logic 210, the navigator logic 240 and the vehicle state logic 230. It should also be clear that the allocation of the functions of the energy management system 200 to the different logic modules is merely by way of example and is used to group similar information logically. The information collected, analyzed and provided to the main energy-management logic 220 can be implemented in any logic location and can be grouped in one or more modules, logic areas and/or functions, which may or may not be logically distinct from the main energy-management logic 220 itself.

The main energy-management logic 220 can use the collected information to define the energy configurations for the devices in the cabin, for example the central heating 250a, the in-seat heating/cooling 250b, the ventilation/fans 250c, the display screens 250d, the central air-conditioning facility 250e and/or any other system 250x that may be helpful to the main energy-management logic 220 in controlling its energy configurations. It is self-evident that the options for the energy configuration for each of the devices in the cabin can be unique to the particular device, and that the energy configuration can vary for a particular device, where different energy configurations can be selected according to the situation in the vehicle cabin. Although some examples of particular devices in the vehicle interior are explained below, these examples shall not be interpreted as restrictive, but merely represent specific examples, which can be extended to other situations, other devices and other energy configurations.

The example of the video screens in the driver's cabin shows that these can constitute an important component for power consumption. Although modern screens in the on state can be very efficient, their sheer size (often 56 inches and more) and the number of screens in modern vehicles (usually three screens for the driver/front passenger, three screens built into the mirrors (rear-view mirror, left and right), two screen in the headrests for the rear passengers, etc.) and also the requirement for high contrast result in relatively high power consumption. These screens need not always be active, however, because the passengers may not be actively engaged with all the screens at the same time. Thus rather than simply keeping all the screens in their fully active mode, the energy management system (for example the energy management system 200) can adaptively alter the energy configuration for a particular screen on the basis of the actual attention of the passengers in the vehicle. The energy management system can thereby follow a multi-layered approach to the energy configurations, with the type of configuration and the extent of the energy savings depending on the current status of the passengers and other factors.

It is self-evident that different energy-saving configurations can be employed according to the attention of the passenger on the active content. If, for example, the facial expression and/or the action of the passenger indicates that he is listening to the audio content being played on the video screen, but the passenger's eyes are looking fixedly out of the window, the energy management system can dim the screen but continue to play the audio content. If the facial expression and/or the actions of the passenger indicate that the passenger has lost interest in the content actively being played (for instance because the passenger is chatting with other passengers or pursuing other activities), the energy management system can not only darken the screen but also suspend the audio playback.

Such a versatile approach can be more than the simple switching on or off of the video; a finely tuned approach can simply dim/switch off the display or suspend the video playback if the energy management system ascertains that the passenger watching the video playback has fallen asleep. If the passenger is asleep over a prolonged time period, the energy management system can switch off the playback device completely until the passenger awakes. In this sense, the energy management system can track the activity level of a passenger with respect to the video playback device, and if the energy management system ascertains that the passenger has changed his activity from “watching” to “sleeping”, it can use a lower-energy configuration. Conversely, the energy management system can use a higher energy configuration if the passenger wakes up and is no longer sleeping. This consideration can of course be made on a passenger-specific basis by using, in order to switch off the passenger's display, the location of the passenger and its corresponding location.

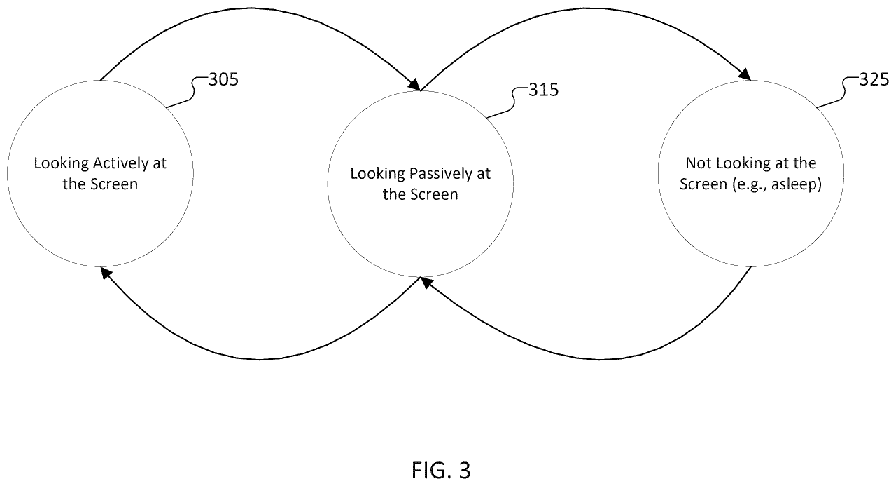

It is self-evident that the changes to the device can include hysteresis, so that the energy configurations are not necessarily altered with every video frame. Alternatively, the energy management system can use a state machine to track the current state of the passenger and to ensure that the transitions provide a positive user experience while saving energy. FIG. 3 shows an example of such a finite state machine, where transitions from left to right (from the active state 305 via the passive state 315 to the state “not watching” 325) can require a longer dwell time (for instance a certain number of frames) in a certain state before a change is made to the right into the lower-energy modes, which are associated with the “passive” or not-watching” states. In contrast, the transitions from right to left (from “not-watching” state 325 via the “passive” state 315 to the “active” state 305) can be made relatively quickly with a shorter dwell time in a certain state before the transition is made to the left to the high-energy states of improved user experience.

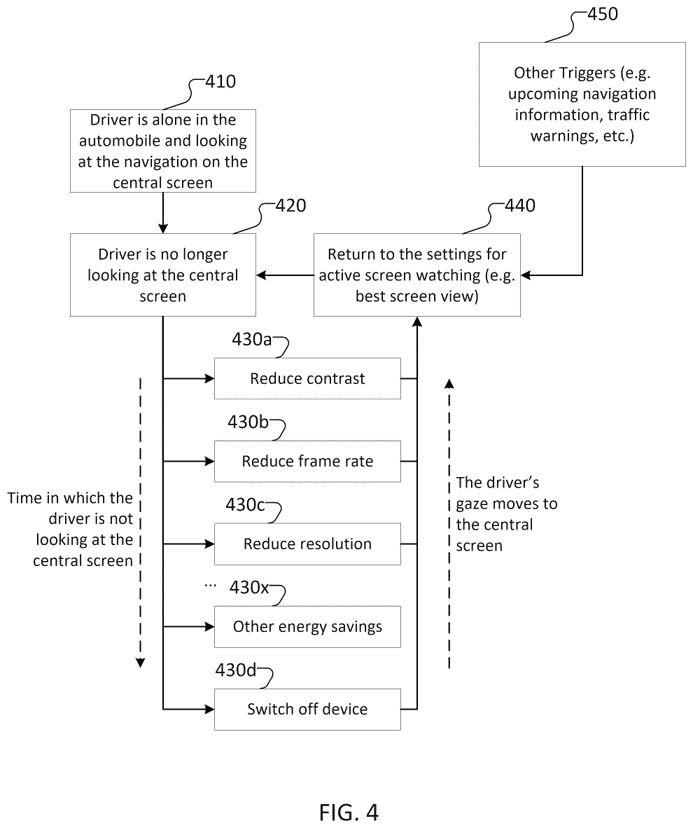

FIG. 4 shows a further example of how the energy management system can control the configuration settings of a video device, which is based on the scenario in which the driver of the vehicle is alone in the car and has activated a navigation program on the console screen or the central screen of the vehicle. In this state 410, in which the driver is actively watching, or is interacting with, the central screen, the energy management system can configure the central screen to allow optimum use (for example in a mode that is not a power-saving mode). If the driver transitions into a state 420 in which he is no longer watching the central screen, the energy management system can start to configure the central screen into lower-energy modes, which can be carried out according to other aspects of the situation and/or the time that the driver has spent in state 420. For example, the energy management system can first reduce, in 430a, the contrast of the screen. As the time in which the driver is not looking at the screen increases, the energy management system can add further aspects, for instance reducing the frame rate (430b), reducing the resolution (430c), or any number of other energy saving measures (430x) (for instance playing just the sound and dimming or switching off the screen). Finally, the energy management system can switch off the central screen completely (430d). Of course, the energy management system can apply each of these types of energy saving measures in any order. If the gaze of the driver returns to the central screen, the energy management system can reset, in 440, the configuration settings back to the settings for active watching (for example, best user experience such as high screen visibility).

Of course, other triggers 450 can also lead the energy management system to reset, in 440, the configuration settings to the settings associated with active viewing. For instance, a navigation message can arrive from the navigation logic indicating that a turn is imminent. Or a traffic message that is meant to be displayed on the traffic screen can cause the energy management system to configure the central screen for active viewing. Of course, the energy management system can configure the screen for active viewing if another passenger directs his gaze to the screen, if a passenger moves his hand towards the screen in order to program a new setting, etc.

While the above examples relate to controlling the energy of video screens, the following examples relate to controlling the heating, cooling and ventilation systems in the vehicle. As regards heating, ventilation and/or air-conditioning, for example, then vehicles usually have a series of configurable air vents, which can be opened or closed according to the ventilation needs of the interior. Furthermore, the ventilation fan can work at different speeds in order to force the air into the vehicle interior at different strengths. It should be clear that the higher fan speeds can consume more power. Therefore, the energy management system can adjust the opening/closing of the air vents and the fan speed to the situation of the passengers and their activities/behavior patterns. For example, if the passenger monitoring logic ascertains that certain seats are unoccupied, it can configure the air vents to be closed at the relevant locations without passengers. This increases the air pressure for the remaining, open air vents, which means that the fan speed can be reduced. If, for example, only the driver and front passenger are taken into account, and the system is set to 100% fan speed but the front passenger is not present, the energy management system can close the relevant air vents and reduce the fan speed by 50%. This equates to a saving of about 100 Watts or 0.5-1% of the entire power consumption of a typical electric vehicle.

It is self-evident that the energy management system can inform the passengers (for instance via a user interface) about the adjustments to the systems in the cabin, and that the passengers have the facility to override such settings through manual input.

The heating and cooling systems are usually large power consumers in a typical vehicle. As already mentioned, the air-conditioning system and the central heating can consume 1 to 5 KW of power, and efficient control of their power consumption can lead to substantial energy savings for the vehicle. For instance, the energy management system can estimate the effect of different settings for the air-conditioning system and heating in order to determine an optimum setting for the interior on the basis of the situation of the passengers and/or other aspects of the vehicle and its movements (for example, clothing worn by the passengers, the time to the destination, the prevailing temperature, the external temperature, etc.).

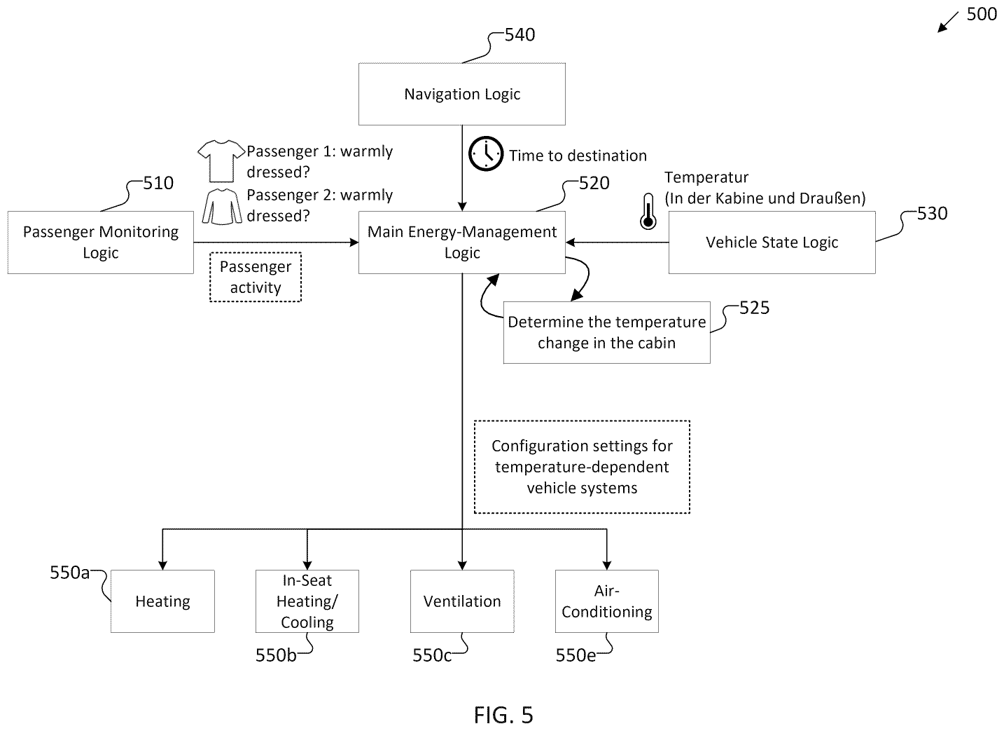

FIG. 5, which is similar to FIG. 2, shows an example of this, with additional annotations about the data that can be exchanged between the various modules and devices of the energy management system. FIG. 5 shows an exemplary information flow in an energy management system 500 (for example, similar to the energy management system 200 of FIG. 2) with reference to an example of using observations of the passengers, navigation information and vehicle information to define the configuration settings for the heating/cooling systems in the cabin. The passenger monitoring logic 510 can provide the main energy-management logic 520 with details about the passengers and their activities. The navigation logic 540 can supply the main energy-management logic 520 with information about the expected time to the destination. The vehicle state logic 530 can provide the main energy-management logic 520 with information about the external temperature of the vehicle, the prevailing temperature in the interior and other information about the state of the vehicle.

Take the example of the vehicle traveling on a cold winter's day to a nearby destination, with two passengers wearing relatively thick winter clothing in the vehicle (as recognized by the passenger monitoring logic 510) and the destination being approximately 10 minutes away (as determined by the navigation logic 540), and the passengers adjusting the heating and the fan speed to the maximum settings. Normally, this would require a considerable amount of power (for example, in the order of 5 KW in a standard electric vehicle). Yet even such a setting would not heat the cabin to the desired temperature because the distance is too short and it takes some time for the heating system to get warm. Therefore, the main energy-management logic 520 can ascertain that another configuration of the heating system is better suited from the perspective of power and passenger comfort. For example, the main energy-management logic 520 can determine, in 525, on the basis of the navigation information and the vehicle state information, the temperature change in the cabin over the expected route. Using this information, the main energy-management logic 520 can ascertain that another configuration setting for the heating system would be better suited to the situation, and as a result, the heating is not set to maximum power. Instead, the main energy-management logic 520 can select a lower setting, which is sufficient for the passengers to feel comfortable during the short journey, taking into account their clothing and activities. This main energy-management logic 520 can provide configuration settings for the heating device 550a (which generates the heat) and/or an in-seat heating/cooling device 550b and the ventilation fans 550c (which blow the air through selected air vents in the vehicle interior).

On the other hand, if the passenger monitoring logic 510 ascertains that the passengers are only lightly dressed for the prevailing cold conditions, the main energy-management logic 520 can set the heating (550a and/or 550b) to a higher level in order to ensure the comfort of the passengers. A further example: if the external temperature on a very hot summer's day is very high and the vehicle is driving out of a cold underground garage, the main energy-management logic 520 can ascertain from the external temperature combined with the current location that heating of the cabin is not required and the climate in the cabin will improve through simple ventilation when the vehicle leaves the garage. Such monitoring allows the main energy-management logic 520 to adjust the configurations to suit the changing situations without wasting energy unnecessarily on running the heating (550a and/or in-seat heating 550b) and/or the air-conditioning system (550e and/or in-seat cooling 550b) and without causing large temperature gradients over time. As a result, the configuration settings by the main energy-management logic 520 can work in a more energy-efficient manner than a simple static setting by the user, and ultimately save energy.

The above examples shall not be interpreted as restrictive but rather shall be understood as examples of how the energy management system can use information about the cabin together with navigation information and/or other vehicle information to make decisions about the configuration of devices in the cabin for better energy savings. It should also be clear that the energy savings can be based on optimization settings/rules which can reconcile the comfort/preferences of the passengers with the objectives of saving energy, and which can each be programmed by the users of the vehicle (for example, via a user interface).

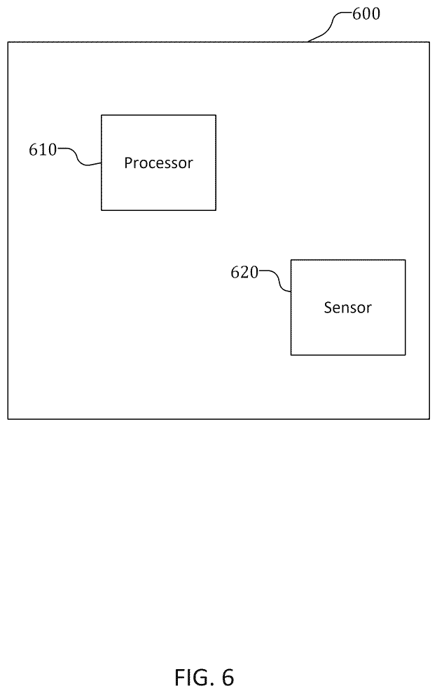

FIG. 6 is a schematic drawing showing an apparatus 600 for an energy management system. The apparatus 600 can contain each of the features that were described with regard to the above-described energy management system. The apparatus 600 of FIG. 6 can be implemented as a device, a method and/or a computer-readable medium which, when executed, realizes the features of the above-described energy management system. It shall be understood that the apparatus 600 is only an example, and other configurations are possible, for instance containing other or additional components.

Apparatus 600 comprises a processor 610, which is configured to determine an energy reduction scheme for a subsystem of a vehicle, wherein the energy reduction scheme is based on a passenger status of a passenger who is within a passenger environment of the vehicle, wherein the energy reduction scheme is configured to reduce the power consumption of the subsystem with respect to the vehicle. Processor 610 is further configured to control a configuration setting of the subsystem of the vehicle, which configuration setting is based on the energy reduction scheme.

In addition to, or in combination with, one of the features of the apparatus 600 that are described in this paragraph or the previous paragraph, processor 610 is further configured to determine a status of an operational component of the vehicle, wherein the operational component relates to the passenger environment. Processor 610 is further configured to determine the energy reduction scheme further based on the status of the operational component with respect to the passenger status. In addition to, or in combination with, one of the features of the apparatus 600 that are described in this paragraph or the previous paragraph, the operational component comprises: a window, wherein the status comprises whether the window is open or closed, to what extent, or a temperature, quality, or quantity of an incoming air stream; an audio/video system, wherein the status comprises its current activity; a heating, ventilation, and/or air-conditioning system, wherein the status comprises its current activity; and/or a seat-temperature control system, wherein the status comprises its current activity.

In addition to, or in combination with, one of the features of the apparatus 600 that are described in this paragraph or the previous two paragraphs, processor 610 is further configured to determine a navigation plan with respect to planned movements of the vehicle. Processor 610 is further configured to adjust the energy reduction scheme based on the navigation plan, or to adjust the navigation plan based on the passenger status. In addition to, or in combination with, one of the features of the apparatus 600 that are described in this paragraph or the previous two paragraphs, processor 610 is configured such that the adjusting of the navigation plan based on the passenger status comprises changing a planned time of arrival at a destination based on whether the passenger status indicates a sleeping passenger. In addition to, or in combination with, one of the features of the apparatus 600 that are described in this paragraph or the previous two paragraphs, processor 610 is further configured to determine the passenger status based on sensor information about the passenger environment of the vehicle.

In addition to, or in combination with, one of the features described in this paragraph or the previous three paragraphs, the apparatus 600 further comprises a sensor 620, which is configured to capture the sensor information about the passenger environment. In addition to, or in combination with, one of the features of the apparatus 600 that are described in this paragraph or the previous three paragraphs, sensor 620 comprises a camera, a liDAR sensor, a wheel sensor, a thermal sensor, an occupancy sensor, and/or an infrared sensor. In addition to, or in combination with, one of the features of the apparatus 600 that are described in this paragraph or the previous three paragraphs, the passenger status within the passenger environment of the vehicle comprises a location of a passenger within the passenger environment, a pose of the passenger, a gaze of the passenger, a behavior of the passenger, a clothing type worn by the passenger, a heart-rate of the passenger, a body temperature of the passenger, an expression of the passenger, and/or perspiration of the passenger.

In addition to, or in combination with, one of the features of the apparatus 600 that are described in this paragraph or the previous four paragraphs, the subsystem comprises a display, wherein the configuration setting comprises a contrast, a brightness level, a backlighting, a resolution, a quality, or a frame rate of the display. In addition to, or in combination with, one of the features of the apparatus 600 that are described in this paragraph or the previous four paragraphs, the subsystem comprises a video playback unit, wherein the configuration setting comprises a playback setting for whether to pause/stop playback on the video playback unit, and/or whether to alter a quality or resolution. In addition to, or in combination with, one of the features of the apparatus 600 that are described in this paragraph or the previous four paragraphs, the subsystem comprises a heating, ventilation and/or air-conditioning system, wherein the configuration setting comprises a fan speed, a temperature, an extent to which a vent should be opened, and/or a zone to be targeted by the heating, ventilation and/or air-conditioning system.

In addition to, or in combination with, one of the features of the apparatus 600 that are described in this paragraph or the previous five paragraphs, the subsystem comprises a seat-temperature control system, wherein the configuration setting comprises a temperature. In addition to, or in combination with, one of the features of the apparatus 600 that are described in this paragraph or the previous five paragraphs, processor 610 is further configured to provide the configuration setting to a passenger in the vehicle and to receive from the passenger edits to the configuration setting. In addition to, or in combination with, one of the features of the apparatus 600 that are described in this paragraph or the previous five paragraphs, the energy reduction scheme comprises a set of rules for determining the configuration setting in relation to another configuration setting, another subsystem, a predetermined energy criterion, a status of an operational component of the vehicle, and/or a navigation plan with respect to planned movements of the vehicle. In addition to, or in combination with, one of the features of the apparatus 600 that are described in this paragraph or the previous five paragraphs, processor 610 is further configured to prioritize the set of rules based on a predetermined criterion.

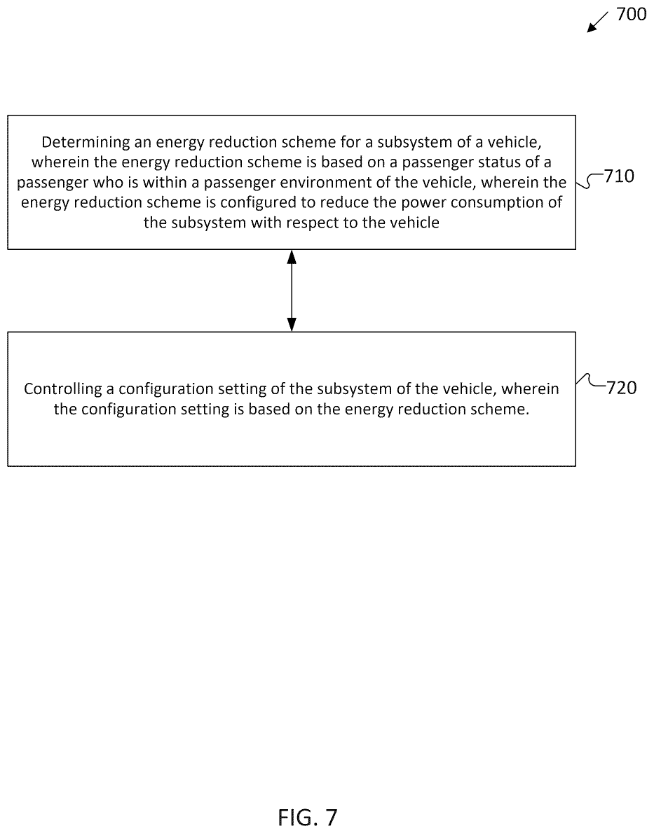

FIG. 7 shows a method 700 for an energy management system. The method 700 can contain each of the features that were described with regard to the above-described energy management system. It shall be understood that the method 700 is only an example, and other configurations are possible, for instance containing other or additional components.

Method 700 comprises, in 710, determining an energy reduction scheme for a subsystem of a vehicle, wherein the energy reduction scheme is based on a passenger status of a passenger who is within a passenger environment of the vehicle, wherein the energy reduction scheme is configured to reduce the power consumption of the subsystem with respect to the vehicle. Method 700 further comprises, in 720, controlling a configuration setting of the subsystem of the vehicle, which configuration setting is based on the energy reduction scheme.

Various examples are described below, which contain one or more features of the above-described energy management systems and/or of those shown in FIGS. 1-7. It can be intended that features described with reference to the devices can also apply to the described method, and vice versa.

Example 1 is an apparatus which comprises a processor, which is configured to determine an energy reduction scheme for a subsystem of a vehicle, wherein the energy reduction scheme is based on a passenger status of a passenger who is within a passenger environment of the vehicle, wherein the energy reduction scheme is configured to reduce the power consumption of the subsystem with respect to the vehicle. The processor is further configured to control a configuration setting of the subsystem of the vehicle, which configuration setting is based on the energy reduction scheme.

Example 2 is an apparatus according to example 1, wherein the processor is further configured to determine a status of an operational component of the vehicle, wherein the operational component relates to the passenger environment. The processor is further configured to determine the energy reduction scheme further based on the status of the operational component with respect to the passenger status.

Example 3 is an apparatus according to example 2, wherein the operational component comprises a window, wherein the status comprises whether the window is open or closed, to what extent, or a temperature, quality, or quantity of an incoming air stream; an audio/video system, wherein the status comprises its current activity; a heating, ventilation, and/or air-conditioning system, wherein the status comprises its current activity; or a seat-temperature control system, wherein the status comprises its current activity.

Example 4 is an apparatus according to any one of examples 1 to 3, wherein the processor is further configured to determine a navigation plan with respect to planned movements of the vehicle. The processor is further configured to adjust the energy reduction scheme based on the navigation plan, or to adjust the navigation plan based on the passenger status.

Example 5 is an apparatus according to example 4, wherein the processor is configured such that the adjusting of the navigation plan based on the passenger status comprises changing a planned time of arrival at a destination based on whether the passenger status indicates a sleeping passenger.

Example 6 is an apparatus according to in one of examples 1 to 5, wherein the processor is further configured to determine the passenger status based on sensor information about the passenger environment of the vehicle.

Example 7 is an apparatus according to example 6, further comprising a sensor configured to capture the sensor information about the passenger environment.

Example 8 is an apparatus according to example 7, wherein the sensor comprises a camera, a LIDAR sensor, a radar sensor, a thermal sensor, an occupancy sensor, and/or an infrared sensor.

Example 9 is an apparatus according to any one of examples 1 to 8, wherein the passenger status within the passenger environment of the vehicle comprises a location of a passenger within the passenger environment, a pose of the passenger, a gaze of the passenger, a behavior of the passenger, a clothing type worn by the passenger, a heart-rate of the passenger, a body temperature of the passenger, an expression of the passenger, and/or perspiration of the passenger.

Example 10 is an apparatus according to any one of examples 1 to 9, wherein the subsystem comprises a display, wherein the configuration setting comprises a contrast, a brightness level, a backlighting, a resolution, a quality, or a frame rate of the display.

Example 11 is an apparatus according to any one of examples 1 to 10, wherein the subsystem comprises a video playback unit, wherein the configuration setting comprises a playback setting for whether to pause/stop playback on the video playback unit, and/or whether to alter a quality or resolution.

Example 12 is an apparatus according to any one of examples 1 to 11, wherein the subsystem comprises a heating, ventilation and/or air-conditioning system, wherein the configuration setting comprises a fan speed, a temperature, an extent to which a vent should be opened, and/or a zone to be targeted by the heating, ventilation and/or air-conditioning system.

Example 13 is an apparatus according to any one of examples 1 to 12, wherein the subsystem comprises a seat-temperature control system, wherein the configuration setting comprises a temperature.

Example 14 is an apparatus according to any one of examples 1 to 13, wherein the processor is further configured to provide the configuration setting to a passenger in the vehicle and to receive from the passenger edits to the configuration setting.

Example 15 is an apparatus according to any one of examples 1 to 14, wherein the energy reduction scheme comprises a set of rules for determining the configuration setting in relation to another configuration setting, another subsystem, a predetermined energy criterion, a status of an operational component of the vehicle, and/or a navigation plan with respect to planned movements of the vehicle.

Example 16 is an apparatus according example 15, wherein the processor is further configured to prioritize the set of rules based on a predetermined criterion.

Example 17 is a method comprising: determining an energy reduction scheme for a subsystem of a vehicle, wherein the energy reduction scheme is based on a passenger status of a passenger who is within a passenger environment of the vehicle, wherein the energy reduction scheme is configured to reduce the power consumption of the subsystem with respect to the vehicle; and controlling a configuration setting of the subsystem of the vehicle, which configuration setting is based on the energy reduction scheme.

Example 18 is a method according to example 17, further comprising: determining a status of an operational component of the vehicle, wherein the operational component relates to the passenger environment, and determining the energy reduction scheme further based on the status of the operational component with respect to the passenger status.

Example 19 is a method according to example 18, wherein the operational component comprises a window, wherein the status comprises whether the window is open or closed, to what extent, or a temperature, quality, or quantity of an incoming air stream; an audio/video system, wherein the status comprises its current activity; a heating, ventilation, and/or air-conditioning system, wherein the status comprises its current activity; or a seat-temperature control system, wherein the status comprises its current activity.

Example 20 is a method according to any one of examples 17 to 19, further comprising: determining a navigation plan with respect to planned movements of the vehicle, and adjusting the energy reduction scheme based on the navigation plan, or to adjusting the navigation plan based on the passenger status.

Example 21 is method according to example 20, wherein the adjusting of the navigation plan based on the passenger status comprises changing a planned time of arrival at a destination based on whether the passenger status indicates a sleeping passenger.

Example 22 is a method according to any one of examples 17 to 21, further comprising: determining the passenger status based on sensor information about the passenger environment of the vehicle.

Example 23 is a method according to example 22, further comprising: capturing (for example by a sensor), the sensor information about the passenger environment.

Example 24 is a method according to example 23, wherein the sensor comprises a camera, a LIDAR sensor, a radar sensor, a thermal sensor, an occupancy sensor, and/or an infrared sensor.

Example 25 is a method according to any one of examples 17 to 24, wherein the passenger status within the passenger environment of the vehicle comprises a location of a passenger within the passenger environment, a pose of the passenger, a gaze of the passenger, a behavior of the passenger, a clothing type worn by the passenger, a heart-rate of the passenger, a body temperature of the passenger, an expression of the passenger, and/or perspiration of the passenger.

Example 26 is a method according to any one of examples 17 to 25, wherein the subsystem comprises a display, wherein the configuration setting comprises a contrast, a brightness level, a backlighting, a resolution, a quality, or a frame rate of the display.

Example 27 is a method according to any one of examples 17 to 26, wherein the subsystem comprises a video playback unit, wherein the configuration setting comprises a playback setting for whether to pause/stop playback on the video playback unit, and/or whether to alter a quality or resolution.

Example 28 is a method according to any one of examples 17 to 27, wherein the subsystem comprises a heating, ventilation and/or air-conditioning system, wherein the configuration setting comprises a fan speed, a temperature, an extent to which a vent should be opened, and/or a zone to be targeted by the heating, ventilation and/or air-conditioning system.

Example 29 is a method according to any one of examples 17 to 28, wherein the subsystem comprises a seat-temperature control system, wherein the configuration setting comprises a temperature.

Example 30 is a method according to any one of examples 17 to 29, further comprising: providing the configuration setting to a passenger in the vehicle and receiving from the passenger edits to the configuration setting.

Example 31 is a method according to any one of examples 17 to 30, wherein the energy reduction scheme comprises a set of rules for determining the configuration setting in relation to another configuration setting, another subsystem, a predetermined energy criterion, a status of an operational component of the vehicle, and/or a navigation plan with respect to planned movements of the vehicle.

Example 32 is a method according to example 31, further comprising: prioritizing the set of rules based on a predetermined criterion.

Example 33 is a computer-readable medium, which stores instructions which, when executed by a processor, cause the processor to perform the method according to any one of examples 17 to 32.

Functions, operations, components and/or features described herein with reference to one or more aspects can be combined with one or more other functions, operations, components and/or features described herein with reference to one or more other aspects, or used in combination with these, or vice versa.

While certain features have been illustrated and described herein, numerous modifications, substitutions, changes and equivalents will be obvious to a person skilled in the art. Therefore, it is evident that the accompanying claims are intended to cover all such modifications and changes, which lie within the scope of protection of the disclosure.

Claimed is:

1. A device comprising:
a processor; and
a memory coupled the processor, wherein the processor is configured, based on instructions stored in the memory, to:
determine, based on a passenger status within a passenger environment of a vehicle, an energy reduction scheme for a subsystem of the vehicle, wherein the energy reduction scheme is configured to reduce power consumption of the subsystem with respect to the vehicle; and
control a configuration setting of the subsystem of the vehicle based on the energy reduction scheme.

2. The device of claim 1, wherein the processor is further configured to:
determine a status of an operational component of the vehicle, wherein the operation component relates to the passenger environment; and
determine the energy reduction scheme further based on the status of the operational component with respect to the passenger status.

3. The device of claim 2, wherein the operational component comprises:
a window, wherein the status comprises whether the window is open or closed, to what extent, or a temperature, quality, or quantity of an incoming air stream;
an audio/video system, wherein the status comprises its current activity;
a heating, ventilation, and/or air-conditioning system, wherein the status comprises its current activity; or
an in-seat temperature control system, wherein the status comprises its current activity.

4. The device of claim 1, wherein the processor is further configured to:
determine a navigation plan with respect to planned movements of the vehicle; and
adjust the energy reduction scheme based on the navigation plan or
adjust the navigation plan based on the passenger status.

5. The device of claim 4, wherein the processor configured to adjust the navigation plan based on the passenger status comprises the processor configured to delay a planned time of arrival to a destination based on whether the passenger status indicates a sleeping passenger.

6. The device of claim 1, wherein processor is further configured to determine the passenger status based on sensor information about the passenger environment of the vehicle.

7. The device of claim 6, the device further comprising a sensor configured to capture the sensor information about the passenger environment.

8. The device of claim 7, wherein the sensor comprises a camera, a LIDAR sensor, a radar, a thermal sensor, an occupancy sensor, or an infrared sensor.

9. The device of claim 1, wherein the passenger status within the passenger environment of the vehicle comprises a location of a passenger within the passenger environment, a pose of the passenger, a gaze of the passenger, a behavior of the passenger, a clothing type worn by the passenger, a heart-rate of the passenger, a body temperature of the passenger, an expression of the passenger, or a perspiration of the passenger.

10. The device of claim 1, wherein the subsystem comprises a display, wherein the configuration setting comprises a contrast, a brightness level, a backlighting, a resolution, or a frame rate of the display.

11. The device of claim 1, wherein the subsystem comprises a video playback unit, wherein the configuration setting comprises a playback setting for whether to pause/stop playback on the video playback unit.

12. The device of claim 1, wherein the subsystem comprises a ventilation system, wherein the configuration setting comprises a fan speed, a temperature, an extent to which a vent should be opened, or a zone to be targeted by the ventilation system.

13. The device of claim 1, wherein the subsystem comprises a in-seat temperature control system, where the configuration setting comprises a temperature.

14. The device of claim 1, wherein the processor is further configured to provide the configuration setting to a passenger within the vehicle and to receive from the passenger edits to the configuration setting.

15. The device of claim 1, wherein the energy reduction scheme comprises a set of rules for determining the configuration setting in relation to other configuration settings, other subsystems, predetermined energy criterion, a status of an operational component of the vehicle, or a navigation plan with respect to planned movements of the vehicle.

16. The device of claim 15, wherein the processor is further configured to prioritize the set of rules based on a predetermined criterion.

17. An apparatus comprising:
a means for determining, based on a passenger status within a passenger environment of a vehicle, an energy reduction scheme for a subsystem of the vehicle, wherein the energy reduction scheme is configured to reduce power consumption of the subsystem with respect to the vehicle; and
a means for controlling a configuration setting of the subsystem of the vehicle based on the energy reduction scheme.

18. The apparatus of claim 17, wherein the apparatus further comprises:
a means for determining a navigation plan with respect to planned movements of the vehicle; and
a means for adjusting the energy reduction scheme based on the navigation plan or a means for adjusting the navigation plan based on the passenger status.

19. A non-transitory computer-readable medium comprising instructions that, when executed by one or more processors, cause the one or more processors to:
determine, based on a passenger status within a passenger environment of a vehicle, an energy reduction scheme for a subsystem of the vehicle, wherein the energy reduction scheme is configured to reduce power consumption of the subsystem with respect to the vehicle; and
control a configuration setting of the subsystem of the vehicle based on the energy reduction scheme.

20. The non-transitory computer-readable medium of claim 19, wherein the instructions further cause the one or more processors to determine the passenger status based on sensor information about the passenger environment of the vehicle.
